(19) United States
(12) Patent Application Publication
(10) Pub. No.: US 2007/0146366 A1
(43) Pub. Date: Jun. 28, 2007

(54) System and method for rasterization order independent line stipple

(75) Inventors: Avinash Seetharamaiah, Chuluota, FL (US); Bimal Poddar, El Dorado Hills, CA (US); William B. Sadler, Folsom, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/317,692

(22) Filed: Dec. 23, 2005

(51) Int. Cl. G06T 11/20

(52) U.S. Cl. 345/443

(57) ABSTRACT

A method and apparatus for rasterizing a line, including determining a start point and initial line step count of the line, determining a line stipple pattern position and repeat count at each point of the line based on the start point of the line and initial line step count and rasterizing the line in an order independent manner. In some embodiments, the line may be rasterized backwards. An approximate reciprocal value for the repeat count may be used.

### BACKGROUND

Implementations of the claimed invention generally may relate to schemes for rasterization and, more particularly, to schemes for rasterization order independent line stipple.

The OpenGL application programming interface (API) provides for selective line stippling capability which determines the pixels to be drawn when a line is rasterized. The line stipple pattern is described in the OpenGL API using a “factor” and a “pattern”. The “pattern” is some sequence of 0's and 1's that describe which pixels are drawn (when bit is 1) or not drawn (when bit is 0). “Factor” is a count that is used to modify the effective line stipple by causing each bit in line stipple “pattern” to be used “factor” times. In some implementations, the line stipple pattern may be 16 bits. The API allows the factor to be in the range [1, 256].

In one illustrative implementation of a line stipple pattern, a line may be drawn with a binary pattern “1111000011110000” with a repeat factor of “3” from pixel 10 to 100. In this implementation, pixels “{10, 11, 12}, {13, 14, 15}, {16, 17, 18}, {19, 20, 21}” are drawn while pixels “{22, 23, 24}, {25, 26, 27 . . . ” are skipped. Each group of pixels enclosed in { } represents one bit in the pattern. The number of pixels in { } is be governed by the “factor”—“3” in this example. Normally a pattern of 1's and 0's may be provided. When a line is drawn, if the pattern indicates a 1, the point if drawn. Else if the pattern indicates a 0, the point is skipped and not drawn.

When the line reaches the end of the pattern, the pattern may be repeated once more. The line stipple pattern may thus be a circular pattern with a starting point. Additionally, when two connected lines are drawn, the line stipple pattern may continue from the first line to the next line—i.e. the line stipple pattern may start anywhere within the 16 bit pattern. In some implementations, masking may be achieved using three parameters: the 16bit line stipple p, the line repeat count r, and an integer stipple counter s.
For example,

$$b = floor ( \frac{s}{r} ) MOD 16 \qquad Eq . ( 1 )$$

Then a fragment is produced if the b^{th} bit of p is 1, and not produced otherwise. The bits of p are numbered with 0 being the least significant and 15 being the most significant. The initial value of s may be zero, and s may be incremented after the production of each fragment of a line segment.

The equation works for walking the line forward (from the start point to the end point) because you started with certain stipple counter and the counter is incremented for every pixel drawn. Assume that at the beginning of line, the stipple counter may be a 100, and at the end of the line 120. Because the line may be walked backward (from the end point to the start point), the stipple counter at the end point (120) may go backwards for that line (Eq (1) no longer works).

It should be noted that existing implementations for line stipple rasterization are for lines which are rasterized from the start point to the end point. In particular, the pixels are produced in order, beginning from the starting point of the line and working towards the ending point. The application of this stipple pattern with the repeat and the arbitrary start location may be trivial for some line rasterization algorithms that walk the line sequentially from a start point to the ending point.

However, some implementations rasterize line segments in a different order (for example, working from the end point to the start point). There may be no obvious way to walk the stipple pattern backwards. For example, for some implementations that provide for line rasterization from top to bottom in screen coordinates irrespective of the line order, the choices may include adding multiple rasterization paths such as bottom to top, right to left and so forth.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 conceptually illustrates a graphics pipeline including line stippling; and

FIG. 2 illustrates an exemplary process of line stippling.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

Embodiments of the invention provide for line stipple rasterization of lines rendered in an arbitrary rasterization order. In particular, in some implementations, the line stipple pattern position and repeat count may be determined at each point of the line based on the start point of the line and initial line stipple counter. The computation of the stipple pattern position and repeat count at the each point of the line may involve a division by the repeat counter. Since the repeat counter may be an arbitrary integer (i.e. not guaranteed to be a power of 2), the exact division. may be gate intensive. For example, when the repeat counter is number such as 2, 4 and 8, the division is not complex because the hardware can just do a shift on the number to get the final number. In contrast, when the repeat counter is a number such as 3, 5 and 7, the result may not be an integer number e.g. 100 divided by 3. The division may thus be complex and gate intensive. In some implementations, the approximate reciprocal value for the repeat counter may be used to minimize the gate intensive division. Since the line stipple requirements of the bits that should be turned on or off is exact, adjustments to the approximate reciprocal division are made in order to ensure exact line stipple rendering. In particular, for each pixel of a line, the following equation may be applied:

$$b = floor ( \frac{s}{r} ) MOD 16$$

where b=bit position in for example, a 16 bit stipple pattern
s=stipple counter defined by Xp-Xs (for x major lines) or Yp-Ys (for y major lines)
Xp=x coordinate at current pixel
Xs=x coordinate of the start vertex of the line (there is a start and end of the line)
Yp=y coordinate at current pixel
Ys=y coordinate of the start vertex of the line (there is a start and end of the line)
r=repeat factor (state), the inverse of the repeat state is the same as the repeat count
MOD=The modulo operation just returns the remainder from dividing any number by the modulo term. A mod B will return the remainder resulting from computing A/B. For example, 17 mod 16 will generate a value of 1.

When walking the stipple pattern and drawing the line is done in synch, Eq. (1) does not have to be solved. However, when the line is walked in an arbitrary order, Eq. (1) may have to be solved. For example, in some implementations, the line is walked backwards (i.e. reverse end of line), and the adjustment is done from the reverse initially. In particular, the computation is performed for every pixel. If the result of the computation is larger than the repeat, the result is adjusted. As the line is walked, the calculation is repeated for every pixel.

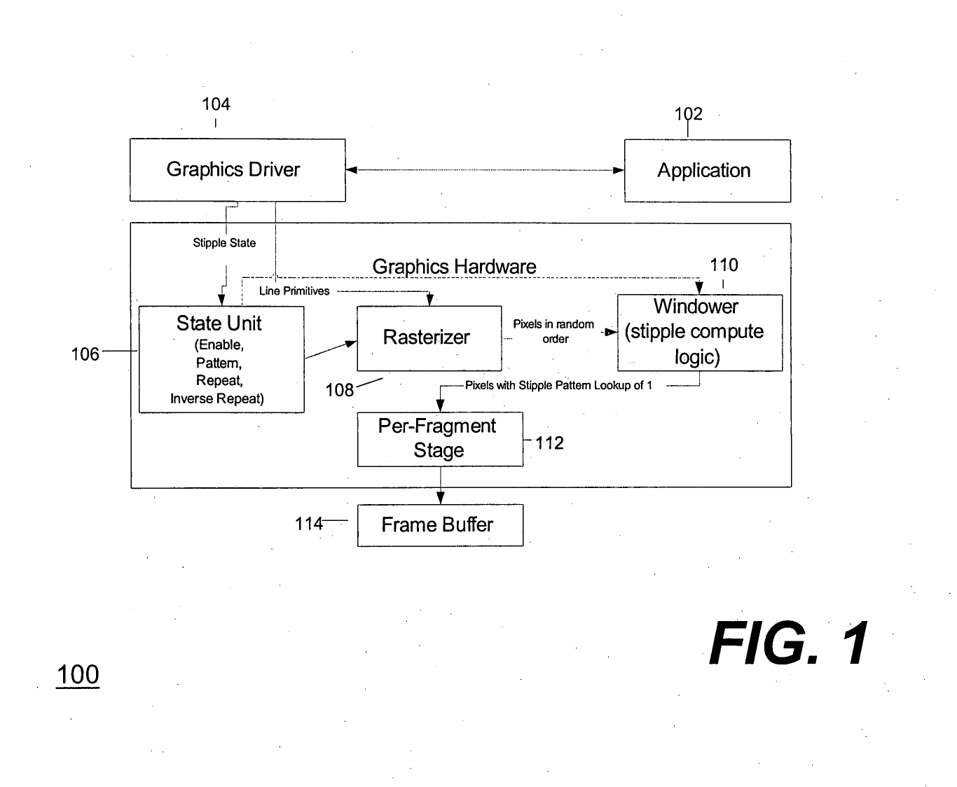

FIG. 1 conceptually illustrates a graphics pipeline 100 including line stippling that renders one or more images to display. Graphics application 102 provides instructions to graphics driver 104 regarding repeat state, inverse repeat state, stipple pattern, the coordinates of the line to be drawn and so forth. Graphics driver 104 sends the required stipple state including the repeat state and inverse repeat state to state unit 106. Graphics driver 104 sends line primitives downstream through rasterizer 108. Some implementations of the invention require a divide by the repeat factor and it is assumed that both the repeat factor and inverse repeat factor are supplied as state to windower 110. Windower 110, including stipple compute logic, receives pixels in random order from rasterizer 108 and starts walking the line primitive. For each pixel in the line, Eq (1) described below will be computed. Windower 110 compute logic receives data from state unit 106 and receives stipple pattern repeat/inverse repeat information from rasterizer 108 about which pixel is currently being walked. Given the pixel x, y start and end points and the other state, stipple compute logic 110 computes that bit pattern and determines whether the pixel is rasterized or not. Pixels that are selected for rasterization are provided to the per-fragment stage 112, the output of which is provided to frame buffer 114.

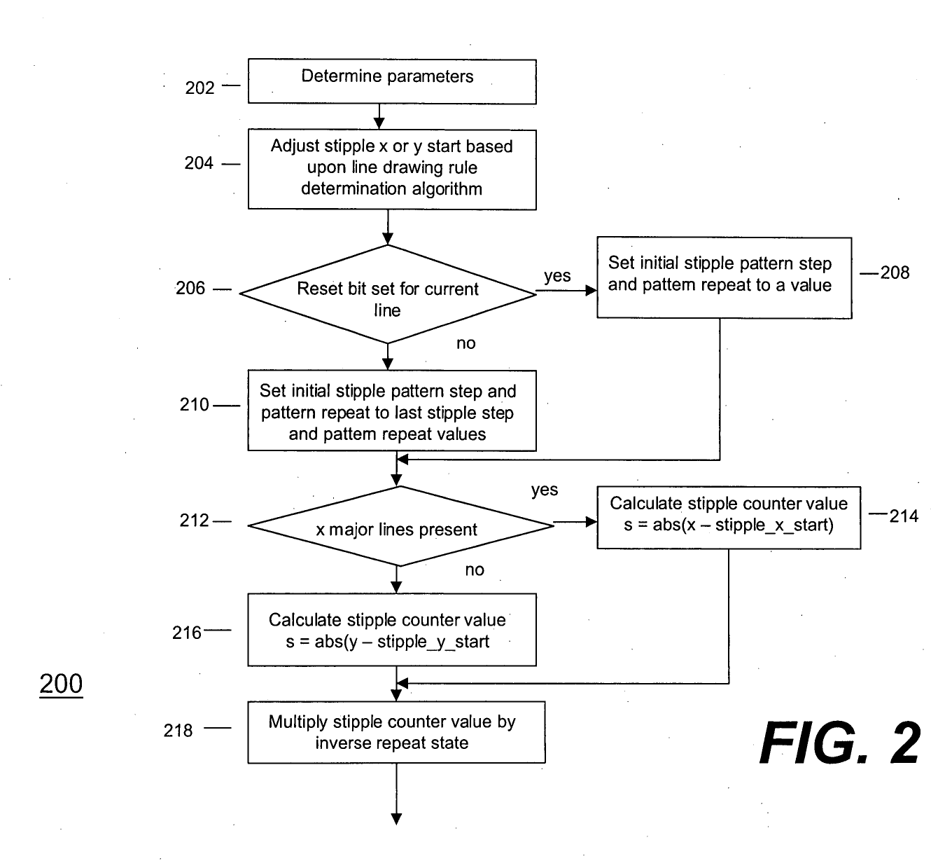

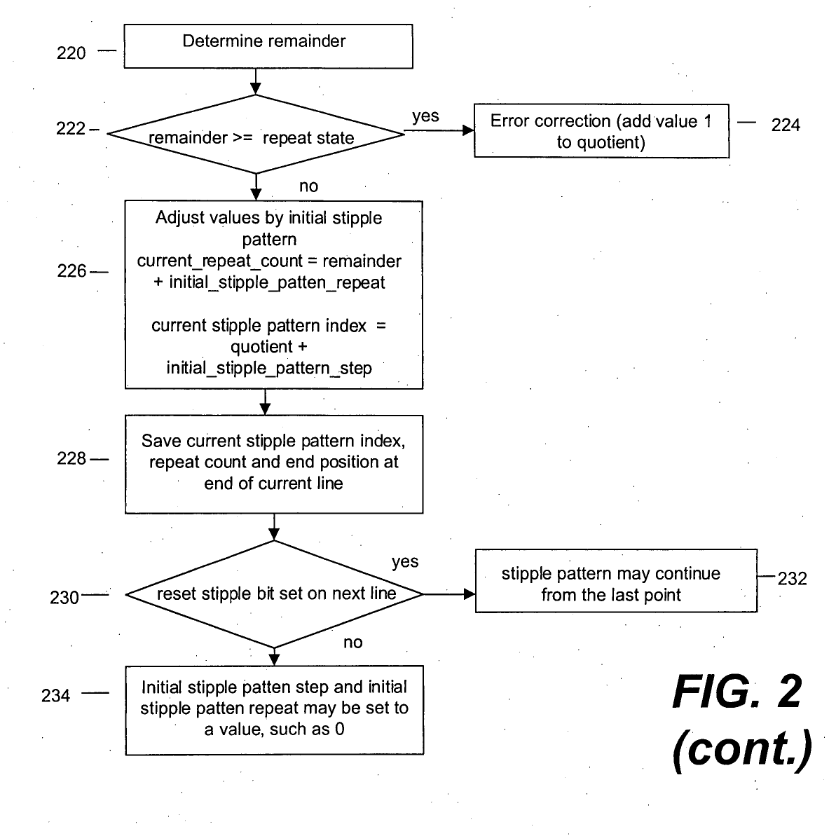

FIG. 2 illustrates an example process 200 of line stippling rendering. Although FIG. 2 may be described with regard to embodiment 100 in FIG. 1 for ease and clarity of explanation, it should be understood that process 200 may be performed by other hardware and/or software implementations. Process 200 may reside, for example, in stipple compute logic 110 shown in FIG. 1.

The following parameters may be initially determined (act 202):

repeat_state=repeat count

inv_repeat_state=input inverse of repeat count

stipple_pattern=input stipple pattern state

stipple_x_start=line_start_x

stipple_y_start=line_start_y

The stipple x line start or stipple y line start may be adjusted based upon a line drawing rule determination algorithm that determines whether end-points are to be drawn or not (act 204). The real end-point being drawn may be used in these computations. One skilled in the art will recognize that any algorithm may be used that relies-on the real end point for computation.

If the reset bit is set for the current line (act 206), the initial stipple pattern step and initial stipple pattern repeat may be set to a value, such as 0 (act 208).

Else if the reset bit is not set for the current value (act 206), the initial stipple pattern step may be set to the last stipple pattern and the initial stipple pattern repeat may be set to the last stipple pattern repeat (act 210). For example, last stipple pattern repeat occurs when the end pixel of one line segment is computed. The position in the stipple pattern and repeat count may be saved.

Next, it is determined whether x major lines are present (act 212). For example, there may be two different types of lines: lines that are less than 45 degrees and lines that are more than 45 degrees. For lines that are less than 45 degrees, every x value may be drawn. For lines that are greater than 45 degrees, every y value may be drawn. In particular, when the line is horizontal, the line may be walked in x order. The distance between two points of the line may be given by the distance in x coordinates. When the line is vertical, the line may be walked in y order. The distance between two points of the line may be given by the distance in y coordinates.

If x major lines are detected (act 212), for each pixel (x, y) in the line, the stipple counter s may be determined by the following equation (act 214):
s=abs(x−stipple_{—}x_start)

If y major lines are detected (act 212), for each pixel (x, y) in the line, the stipple counter (s) may be determined by the following equation (act 216):
s=abs(y−stipple_{—}y_start)
In some implementations, the difference in hardware may be kept in 14 bits. One skilled in the art will recognize that the number of bits may be different on some implementations. The novelty is using the truncated precision on the inverse. Actual detailed precision may not be required. Stipple counter s may be computed by taking the absolute value of the difference between two line positions (x or y difference). The stipple counter may then be used to compute how many units in the stipple pattern needs to be walked (compute quotient/remainder). Once computed, the value may be adjusted by initial values from the previous line.

The stipple counter value s may be multiplied by the inverse repeat state (act 218).
quotient=s*inv_repeat_state
Results of this computation may be accurate except for the last bit due to the chosen precision for “inv_repeat_state.” It is also noted that “inv_repeat_state” in this limited precision may be obtained by truncating the exact value so that the error in computation may be only in one direction. The remainder may then be computed (act 220) by initially multiplying the integer of the quotient by the repeat state, resulting in a temporary value:
temp=quotient*repeat_state
The remainder may then be computed by subtracting result from the original s term:
remainder=s−temp

Based upon the remainder computed in act 218, it is determined whether error correction is needed (act 222).

If remainder>=repeat state (act 222), error correction may be provided (act 224). In some implementations, the value 1 may be added to the quotient. The remainder=remainder−repeat state. Since the error may only be in one direction and off by 1-bit, the value “1” may be added. The result of the calculation may be accurate except for the last bit.

Values may then be adjusted by the initial stipple pattern (act 226).
current repeat_count=remainder +initial_stipple_pattern_repeat
current stipple pattern index=quotient+initial_stipple_pattern_step

At the end of the current line, the current stipple pattern index, repeat count and end position may be saved (act 228) and used for starting the next line of a line strip.

It is then determined if the reset stipple bit is set on the next line (act 230).

If the reset stipple bit is not set on the next line (act 230), the stipple pattern may continue from the last point (act 232).

If the reset bit is set on the next line (act 230), the initial_stipple_pattern_step and initial_stipple_pattern_repeat may be set to a value, such as 0 (act 234). In addition, the current_stipple_pattern_step and current_stipple_pattern_repeat may be context saved and restored.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, in some implementations, the process shown in FIG. 2 may also be used to generate anti-aliased stippled lines with a slight modification. Instead of computing s as delta x (or y), we could use the Lo1 (Lo2) distance. We would choose the appropriate Lo term (1 or 2) based on the start point of the line. This should make the stipple pattern be perpendicular to the long dimension of the line.

Further, at least some of the acts in FIG. 2 may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed is:

1. A method for rasterizing a line, comprising:
determining a start point and initial line step count of the line;
determining a line stipple pattern position and repeat count at each point of the line based on the start point of the line and initial line step count; and
rasterizing the line in an order independent manner.

2. The method claimed in claim 1, wherein rasterizing the line in an order independent manner comprises rasterizing the line backwards.

3. The method claimed in claim 1, wherein determining a line stipple pattern position and repeat count at each point of the line based on the start point of the line and initial line step count further comprises:
using an approximate reciprocal value for the repeat count.

4. The method claimed in claim 1, wherein determining a line stipple pattern position and repeat count at each point of the line based on the start point of the line and initial line step count further comprises computing for each pixel
$$b = floor ( \frac{s}{r} ) MOD 16$$
where b=bit position in for example, s=stipple counter, r=repeat factor, MOD=modulo operation that returns the remainder from dividing any number by the modulo term.

5. The method claimed in claim 4, further comprising:
adjusting the repeat if the bit position computation is larger than the repeat.

6. A machine-accessible medium including instructions that, when executed, cause a machine to:
determine a start point and initial line step count of the line;
determine a line stipple pattern position and repeat count at each point of the line based on the start point of the line and initial line step count; and
rasterize the line in an order independent manner.

7. The machine-accessible medium of claim 6, further including instructions that, when executed, cause the machine to rasterize the line backwards.

8. The machine-accessible medium of claim 6, wherein determining a line stipple pattern position and repeat count at each point of the line based on the start point of the line and initial line step count further includes instructions that, when executed, cause the machine to:
use an approximate reciprocal value for the repeat count.

9. The machine-accessible medium of claim 6, wherein determining a line stipple pattern position and repeat count at each point of the line based on the start point of the line and initial line step count further includes instructions that, when executed, cause the machine to:
compute for each pixel
$$b = floor ( \frac{s}{r} ) MOD 16$$
where b=bit position in for example, s=stipple counter, r=repeat factor, MOD=modulo operation that returns the remainder from dividing any number by the modulo term.

10. The machine-accessible medium of claim 6, further including instructions that, when executed, cause the machine to:
adjusts the repeat if the bit position computation is larger than the repeat.

11. An apparatus comprising:
a state unit to receive pixel information including stipple state including the repeat state and inverse repeat state to state unit;
a rasterizer to receive the pixel information;
a windower including logic to determine a start point and initial line step count of the line, determine a line stipple pattern position and repeat count at each point of the line based on the start point of the line and initial line step count and rasterize the line in an order independent manner.

12. The apparatus claimed in claim 11, wherein the logic rasterizes the line in an order independent manner comprises rasterizing the line backwards.

13. The apparatus claimed in claim 1 1, wherein the logic to determine a line stipple pattern position and repeat count at each point of the line based on the start point of the line and initial line step count further comprises:
using an approximate reciprocal value for the repeat count.

14. The apparatus claimed in claim 1 1, wherein the logic to determining a line stipple pattern position and repeat count at each point of the line based on the start point of the line and initial line step count further comprises computing for each pixel
$$b = floor ( \frac{s}{r} ) MOD 16$$
where b=bit position in for example, s=stipple counter, r=repeat factor, MOD=modulo operation that returns the remainder from dividing any number by the modulo term.

15. A system comprising:
a state unit to receive pixel information including stipple state including the repeat state and inverse repeat state to state unit;
a rasterizer to receive the pixel information;
a windower including logic to determine a start point and initial line step count of the line, determine a line stipple pattern position and repeat count at each point of the line based on the start point of the line and initial line step count and rasterize the line in an order independent manner; and
a graphics memory for storing the pixel information.

16. The system claimed in claim 15, wherein the logic rasterizes the line in an order independent manner comprises rasterizing the line backwards.

17. The system claimed in claim 15, wherein the logic to determine a line stipple pattern position and repeat count at each point of the line based on the start point of the line and initial line step count further comprises:
using an approximate reciprocal value for the repeat count.

18. The system claimed in claim 15, wherein the logic to determining a line stipple pattern position and repeat count at each point of the line based on the start point of the line and initial line step count further comprises computing for each pixel
$$b = floor ( \frac{s}{r} ) MOD 16$$
where b=bit position in for example, s=stipple counter, r=repeat factor, MOD=modulo operation that returns the remainder from dividing any number by the modulo term.
